(19) United States
(12) Patent Application Publication
(10) Pub. No.: US 2012/0036077 A1
(43) Pub. Date: Feb. 9, 2012

(54) SYSTEM AND METHOD FOR FILING LEGAL DOCUMENTS

(76) Inventor: Thomas F. Quinn, JR., Lexington, MI (US)

(21) Appl. No.: 13/265,208

(22) PCT Filed: Apr. 21, 2010
(86) PCT No.: PCT/US10/31863

§ 371 Date: Oct. 19, 2011

Related U.S. Application Data
(60) Provisional application No. 61/171,957, filed on Apr. 23, 2009.

(51) Int. Cl. G06Q 50/18

(52) U.S. Cl. 705/310; 705/311

(57) ABSTRACT

A system is provided that has a filing manager for managing the filing of legal documents in a plurality of offices. The filing manager communicates with a client, and service providers including a drafting law firm, a translation partner, filing agents and designated prosecution agents. The filing manager includes a database for storing data relevant to the filing of a legal document. The filing manager also includes process circuitry configured to compute and execute a routine to manage the filing of legal documents.

### FIELD OF THE INVENTION

The present invention generally relates to managing the filing of legal documents, and more particularly relates to a system and method for managing the filing of legal documents in a plurality of governmental offices.

### BACKGROUND OF THE INVENTION

Many companies file patent applications and other legal documents in many countries throughout the world. Legal documents, such as patent applications, are typically filed in a designated patent office operated by a governmental agency in the corresponding country in which the office is located. In each country, typically there are statutory requirements and formal procedures that must be followed for filing patent applications and each patent office charges governmental fees. Additionally, many patent offices typically regulate those individual practitioners that can practice in the patent office.

In preparation for the filing of a patent application, an applicant, such as one or more inventors, and/or an assignee, such as a company, typically will have the patent application drafted by an outside law firm who represents the applicant or “client” (e.g., a company). It is common practice to file the application initially in the originating country and to subsequently file foreign counterpart applications in a plurality of foreign countries within the requisite time period (e.g., one year) or to file a PCT application before entering individual countries. At the client's instruction, the drafting law firm may coordinate the foreign filings of the applications with a network of foreign associates authorized to practice in various countries. Each foreign associate will receive the patent application to be filed in that corresponding country and will incur costs associated with the filing of the legal documents in that country.

In connection with the filing of such legal documents, the applicant usually will incur fees. Such fees generally may include obtaining translations into the appropriate language, reviewing and editing the application to meet local patent office requirements, law firm fees such as minimum filing fees, and governmental fees associated with each country's patent office. Much of the cost involved in filing such legal documents can be viewed as administrative activities. Unfortunately, the resulting cost of pursuing patent protection in a large number of countries typically becomes very expensive due to current inefficient practices.

There is a growing pressure for corporate counsel to monitor and implement cost savings, particularly for legal document filings. In order to monitor costs realized for filing various applications around the world, in-house corporate counsel generally must become significantly involved in the management of the filings sufficient to understand what legal and administrative services are needed, when such services are due and how such services can be performed reliably and at a fair cost. Accordingly, it may be desirable for corporate counsel to have a tool to help manage the filing of legal documents throughout the world in a manner that allows them to control costs and maintain quality for legal document filings.

### SUMMARY OF THE INVENTION

In accordance with one aspect of the present invention, a system is provided for managing the filing of legal documents in a plurality of offices for a client. The system comprises a database for storing legal document related data relevant to the filing of a legal document, and a communication link adapted to communicate the legal document data within the database to a plurality of service providers. The system further includes process circuitry configured to execute a routine to manage the filing of legal documents. The routine comprises the steps of receiving filing order form information relating to legal documents from a client, storing the filing order form information in the database, generating a request for information that is communicated to at least one of the service providers that prepared the legal documents, sending at least some of the order form information to a translation partner when translation into one or more appropriate languages is necessary, receiving one or more translations from the translation partner, sending filing documents to one or more filing agents for filing in appropriate offices, sending filing documents to prosecution agents in designated countries, and sending a confirmation of filing to the client.

According to another aspect of the present invention, a filing management system is provided for managing the filing of patent applications to be filed in a plurality of patent offices located in various countries. The system includes a filing manager database for storing patent application data relating to individual patent applications, and general instruction data relating to general instructions and criteria for determining when the general instructions should be used, a communication link adapted to communicate instructions and requests, which relate to patent application data and general instruction data stored within the filing manager database, between the filing manager database and a client, a service provider that prepared the patent application, a translation partner and a prosecuting agent. The filing manager further includes process circuitry for managing the timely filing of one or more patent applications and configured to execute one or more routines that manage the communication of the instructions and the requests via the communication link and further configured to execute routines that use the patent application data to calculate a patent application filing deadline date and deadline dates for each of the instructions and the requests communicated, and that determine if the instructions and requests have been responded to before the deadline and before the filing deadline date. According to further aspects of the invention, at least one of the routines further comprises the steps of receiving application filing order form information from the client and storing the application order form information in the filing manager database, generating a request for information and communicating this request to a service provider that prepared the application, sending at least some of the order form information to the translation partner for applications requiring translation into one or more appropriate languages, receiving translations from the translation partner, sending filing documents to filing agents for filing of the patent application in appropriate offices, sending filing documents and any other relevant documents to the prosecuting agent and forwarding confirmation of the filed documents to the client.

According to a further aspect of the present invention, a method for managing the filing of legal documents in a plurality of offices for a client is provided. The method comprises the steps of receiving legal document filing order form information from a client that designates at least one country where the legal documents are to be filed, and storing the filing order form information in a database in a filing manager. The method uses a routine within the database to calculate at least one filing deadline for filing of the legal documents. The method then includes the step of generating a request for information including a deadline for receiving the information and communicating the request to a service provider that prepared the legal documents. The method also includes the steps of communicating to a translation partner at least some of the order form information, and a request for translation to the legal documents into one or more appropriate languages for the countries designated by the client that require translation, and receiving one or more translations from the translation partner. The method further includes the steps of sending filing documents to one or more filing agents for filing in appropriate offices and receiving confirmation of the filing of legal documents in foreign offices, and forwarding a confirmation of filing to the client. According to a further aspect of the invention, the method then further includes the steps of sending filing documents and any other relevant documents to prosecution agents.

These and other aspects, objects, and features of the present invention will be understood and appreciated by those skilled in the art upon studying the following specification, claims, and appended drawings.

### BRIEF DESCRIPTION OF DRAWINGS

In the drawings:

FIG. 1 is a block/flow diagram illustrating a system for managing the filing of legal documents, according to one embodiment;

FIG. 2 is a block diagram further illustrating the system for managing the filing of legal documents, according to a first embodiment;

FIG. 3 is a block diagram illustrating the system for managing the filing of legal documents, according to a second embodiment;

FIGS. 4A and 4B are a flow diagram illustrating a routine for managing the filing of legal matters, according to one embodiment;

FIG. 5 is a flow diagram illustrating a routine for invoicing a client for the filing of legal matters;

FIG. 6 is a page printout showing a system form where instructions for foreign filing are entered and relevant documents are docketed and tracked according to one example;

FIG. 7 is a routine for managing the progress of the work to be performed by various agents;

FIG. 8 is a block diagram illustrating the filing service used in conjunction with an intellectual property cost management service and docketing and annuity payment service, according to one embodiment; and

FIG. 9 is a page printout showing a menu from the filing manager depicting an interface for executing the one or more routines.

### DETAILED DESCRIPTION OF PREFERRED EMBODIMENTS

Various aspects of the system and method of the present invention disclosed herein, along with the accompanying drawings referenced herein, are intended to be exemplary and not limiting. It is understood that other embodiments may be utilized and fall within the scope of the appended claims without departing from the spirit of the invention.

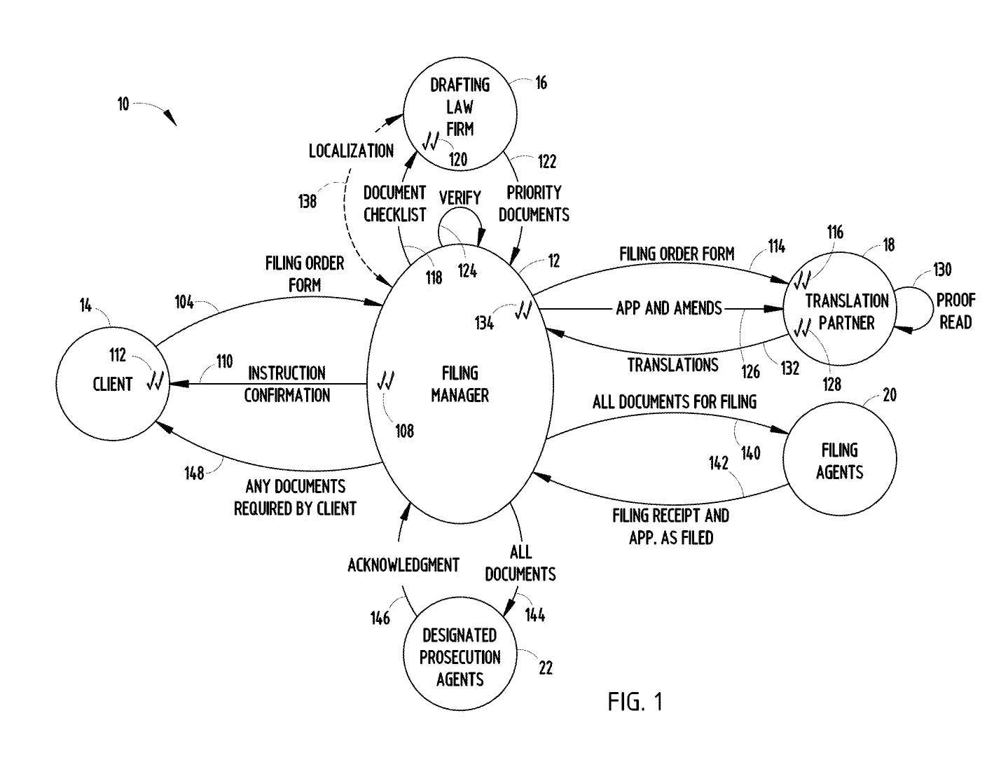

Referring to FIGS. 1-3, a system 10 for managing the filing of legal documents, shown and described herein as patent applications, in a plurality of offices, such as patent offices in various countries, for a client is illustrated according to one embodiment. The system 10 includes a filing manager 12 adapted to communicate with a client 14 and one or more of a plurality of service providers shown including a drafting law firm 16, a translation partner 18, a plurality of filing agents 20, and designated prosecution agents 22. The filing manager 12 includes a communication link adapted to communicate with the client 14 and each of the plurality of service providers 16, 18, 20 and 22, and a filing manager database for storing data relevant to the filing of legal matters. The filing manager 12 also includes process circuitry configured to execute one or more routines to manage the filing of legal documents in various receiving offices throughout the world on behalf of the client 14.

The system 10 by way of the filing manager 12 manages the filing of legal documents and, in doing so, communicates requests and instructions, including data relevant to filing to the client 14 and the plurality of service providers 16, 18, 20 and 22. The client 14 typically may include the owner of a legal document, such as the owner of an invention to be covered by a patent application. The client 14 may include an individual inventor, joint inventors, an assignee, such as a company, or other agent authorized to handle filing and responsibility for such legal matters.

The drafting law firm 16 may include an individual patent practitioner including an agent, attorney or other authorized practitioners or a law firm that deals with preparing and filing the legal documents, such as patent applications. In some cases, the drafting law firm may also be an “in-house” attorney, agent or staff that is employed by the client. The patent application practitioners associated with the drafting law firm 16 typically are authorized to practice in the patent office in the country where they are located and often in the same country where the client 14 is located. Typically, an employee of the client 14 will conceive of an invention and the client will request that a patent application covering the invention be prepared and filed in one or more countries. The drafting law firm 16 will typically handle the drafting of the patent application in the country in which it is located and authorized to practice.

The translation partner 18 employs translation experts for handling language translations of the legal documents. The translation experts may include experts having expertise in one or more technology areas (e.g., electrical technology, biotechnology, automotive, etc.), and expert linguists that are specialists for language translations (e.g., French, Spanish, Russian, etc.). The translation partner 18 will typically translate the legal documents from one language to one or more other languages. Typically, the translation will include the translation expert having expertise in a particular technology area for translating the original document and the expert linguist reviewing or proofing the translated documents or vice versa.

The filing agents 20 include a plurality of filing agents located throughout the world that operate as agents of the filing manager 12 to file the legal documents in designated countries throughout the world. The filing agents 20 may be hired by the filing manager 12 or may be hired directly by the client 14. The filing agents 20 typically are authorized to handle filing responsibility for such legal matters in the country of interest.

The designated prosecution agents 22 are agents located throughout the world that are designated to handle prosecution of the legal documents, such as patent applications, after the applications have been filed in the corresponding countries. The designated prosecution agents 22 typically are authorized to handle prosecution of such legal matters in the corresponding countries. The prosecution agents 22 may be hired agents of the client 14 or may be hired by the filing manager 12. It should be appreciated that the filing agents 20 and the designated prosecution agents 22 may be the same or different agents.

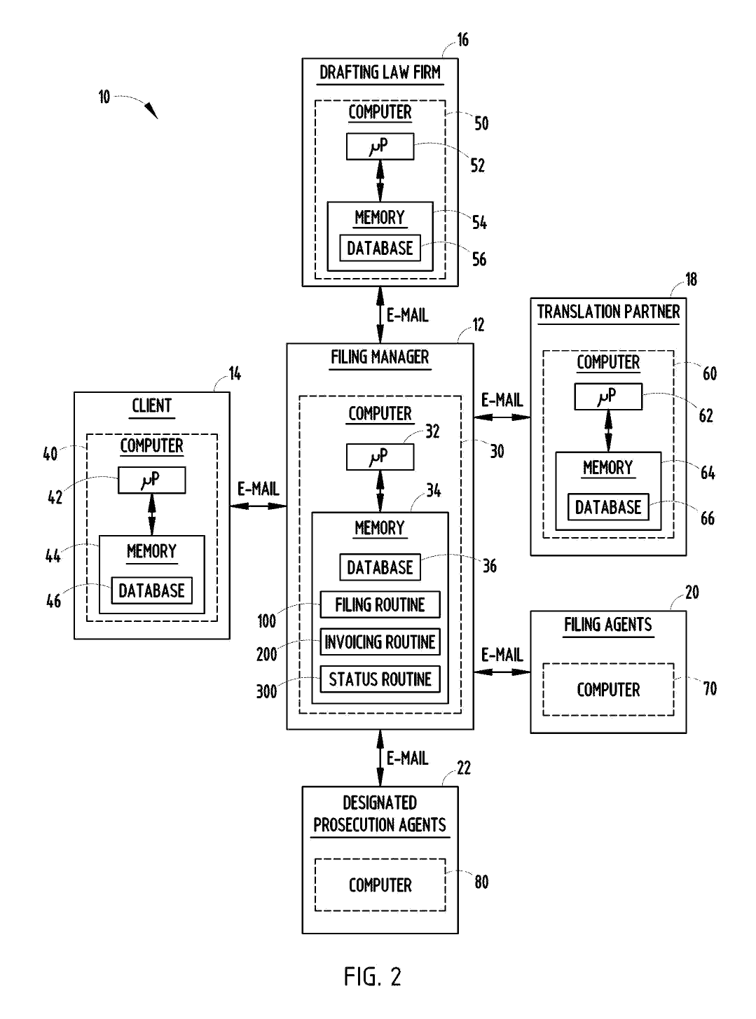

The system 10 is shown in FIG. 2 having the filing manager 12 communicating with the client 14 and the plurality of service providers by way of e-mail, according to a first embodiment. In doing so, the filing manager 12 has a communication link that sends and receives electronic messages in the form of e-mails via a conventional wire or wireless signal communication transmission to an e-mail address. The filing manager 12 has control circuitry shown implemented as a computer 30 having a microprocessor 32 and memory 34. It should be appreciated that any analog and/or digital control circuitry may be employed to process the data, execute one or more routines, and handle communication with each client 14 and the various service providers 16, 18, 20 and 22. Memory 34 may include volatile and/or non-volatile memory including, but not limited to, random access memory (RAM), read-only memory (ROM), electronically erasable programmable read-only memory (EEPROM), flash memory and other known memory storage mediums. Stored within memory 34 is a database 36, a filing routine 100, an invoicing routine 200 and a status routine 300. The routines 100, 200 and 300 may be executed by the microprocessor 32. The database 36 stores legal document related data relevant to the filing of one or more legal documents.

The client 14 is shown having a computer 40 which includes a microprocessor 42 and memory 44. Stored within memory 44 is a client database 46 which contains the filing order form instruction information including filing instructions, priority data, filing dates, etc. The client 14 is shown communicating with the filing manager 12 by way of e-mail according to conventional signal communication. It should be appreciated that the client 14 may communicate filing instructions by way of a filing order form to the filing manager 12 and may receive therefrom instruction confirmations and requests for documents from the filing manager 12. In addition, the client 14 may perform a double-check of the instruction confirmation against data in the client database 46.

The drafting law firm 16 is shown also including a computer 50 having a microprocessor 52 and memory 54. Stored within memory 54 is a law firm database 56 which contains data relating to the patent application, the corresponding drawings, declarations, assignment, priority data and due date deadlines. The drafting law firm 16 likewise communicates with the filing manager 12 by way of e-mail using conventional signal communications. The drafting law firm 16 may receive a document checklist and a request for localization from the filing manager 12 and may provide information and priority documents back to the filing manager 12. In addition, the drafting law firm 16 performs a double-check of the data in the law firm database 56.

The translation partner 18 has a computer 60 including a microprocessor 62 and memory 64. Stored within memory 64 is a translator database 66. The translation partner 18 receives the filing order form and any application and amendments identified by the filing manager 12 as requiring translation. The translation partner 18 translates the documents into one or more languages and transmits the translated documents back to the filing manager 12. Additionally, the translation partner 18 will proof read the translated documents. In doing so, a technology expert may translate the documents initially, and an expert linguist may proofread the translated documents for accuracy. Further, the translation partner 18 provides double-checks of the data in the translator database 66 against the information provided by the filing manager 12 taken from the order form. It should be appreciated that each of the client 14, drafting law firm 16, translation partner 18 and filing manager has its own database for storing data relevant to the filing of legal matters, such that the database entries may be checked and double-checked for accuracy.

The filing agents 20 each include a computer 70 shown communicating with the filing manager 12 by way of e-mail. The filing manager 12 will identify all documents necessary for filing and communicate them to the filing agents 20. The filing agents 20 will handle the filing of the appropriate documents in countries designated by the filing manager 12, and will forward the filing receipts and applications as filed back to the filing manager 12. Similarly, the designated prosecution agents 22 likewise include a computer 80 shown communicating with the filing manager 12 by way of e-mail. The designated prosecution agents 22 will receive all documents identified by the filing manager 12 as necessary for prosecution from the filing manager 12, including the applications and other related documents. The designated prosecution agents 22 will provide acknowledgements back to the filing manager 12 upon receipt of the application and other documents, and handle prosecution matters for the filed application.

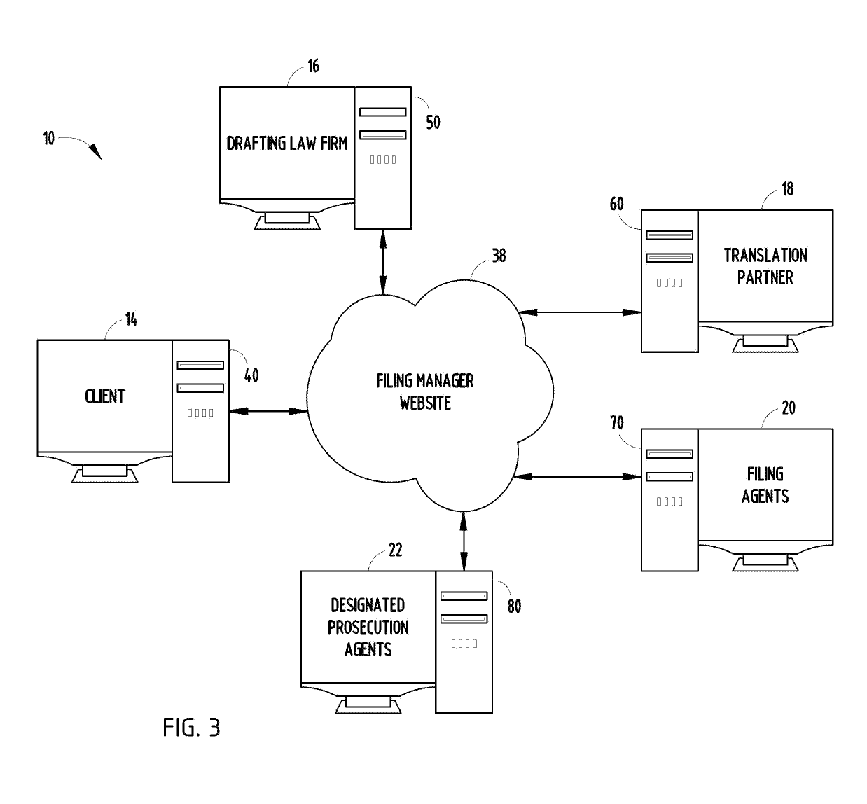

Referring to FIG. 3, the system 10 is shown having the filing manager configured as a filing manager web site 38, according to a second embodiment. In this embodiment, the client 14 and one or more of the plurality of service providers including a drafting law firm 16, translation partner 18, filing agents 20 and designed prosecution agents 22, communicate with the filing manager by way of the filing manager web site 38 by way of corresponding computers 40, 50, 60, 70 and 80 via internet connection. This secure internet connection embodiment offers direct transfer of data between the filing manager 12 and client 14 and each service provider and allows for easy management of the data by managing the common web site 38 hosted or operated by the filing manager 12. It should be appreciated that the various communications between the filing manager 12 and the client 14 and each of the plurality of service providers 16, 18, 20 and 22 as described herein may be implemented by conventional data and message communications including e-mail or internet connection through a web site, according to various embodiments.

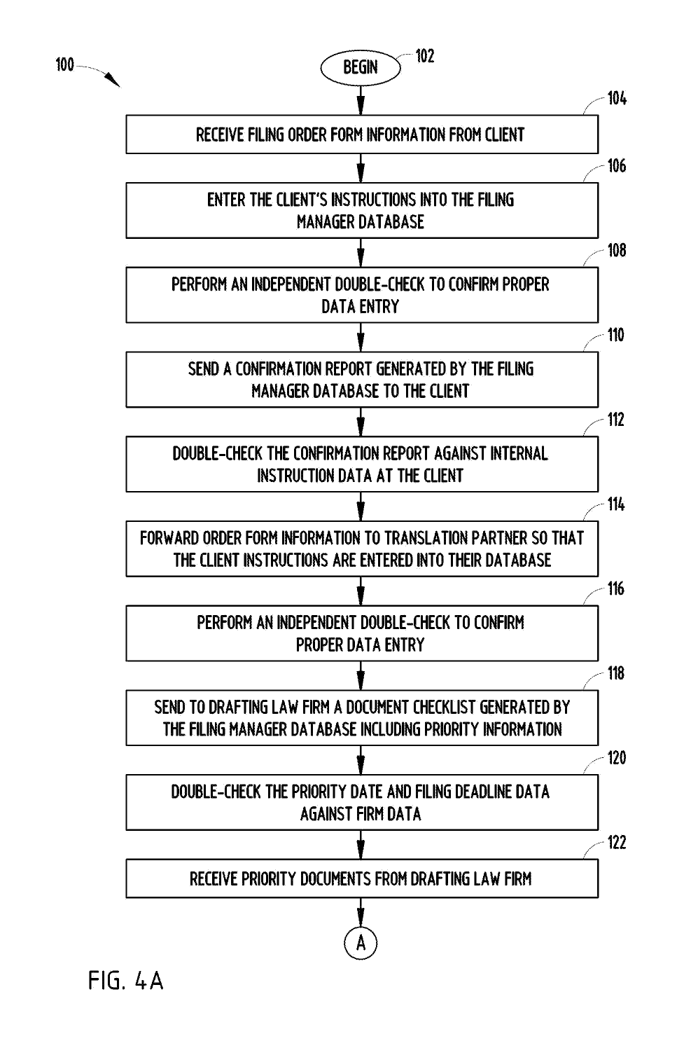

To manage the filing of legal documents, the filing manager 12 executes a filing routine 100. The filing routine 100 is illustrated in FIGS. 1, 4A and 4B, according to one embodiment. Filing routine 100 begins at step 102 and proceeds to step 104 to receive a filing order form from the client 14. The filing order form may include an electronic order form having data entered by the client 14 into a template that may be viewed and/or downloaded to the filing manager 12, according to one embodiment. In this embodiment, the data for the client filing order form may be entered into a computer 40 at the client 14 and e-mailed to the filing manager 12 to provide the instructions for filing. According to another embodiment, the data for the client filing order form may be entered into the filing manager's web site 38 via a secure connection. According to other embodiments, the client 14 or the client's drafting agent 16 may otherwise communicate at least some of the filing order form instructions to the filing manager 12 verbally, by mail, by fax, or in other forms for manual entry into the filing manager 12 by a user.

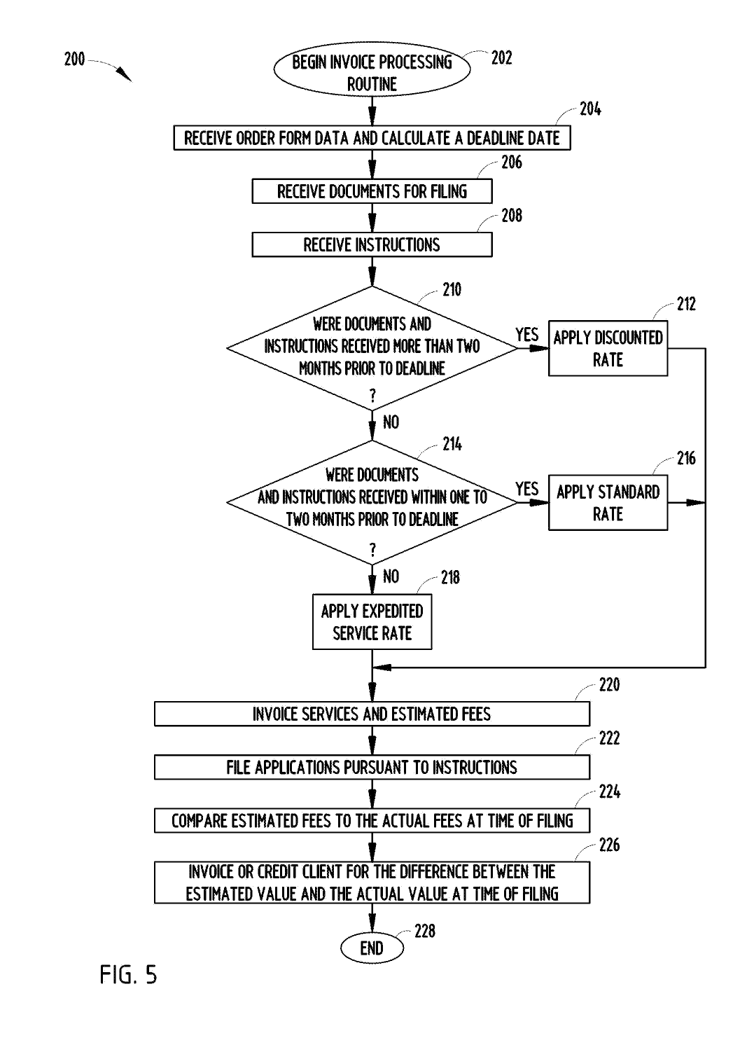

One example of a client filing order form 90 is illustrated in FIG. 6. The client filing order form 90 information includes information relating to the legal document(s) to be filed and may include information about the client, law firm that prepared the legal documents, the countries where the client would like to file the documents, the type of legal document filing, for example PCT patent applications or national patent applications, and the identity of the agents selected by the client to prosecute the patent application in each of the countries selected by the client. In addition, when the client 14 is ordering the filing of patent applications, information in the client order form 90 may include the name of the priority country, the date the matter was opened, the earliest priority date for the legal matter, related priority application information such as one or more priority application numbers, and any other specific filing instructions. Based upon the information provided, the filing manager 12 and system 10 can calculate all applicable filing deadline dates, which are dependent upon the priority information, the country where applications are to be filed and the types of filings requested. It should be appreciated that the legal document may include a utility patent application, a design patent application, a utility model application and various other patent applications as generally recognized in various countries, according to one embodiment. According to other embodiments, the legal document may include a trademark application or a copyright application. For a U.S. utility patent application being filed in other countries, the client 14 may also attach an electronic copy or provide hard copies of the patent application, the corresponding drawings, the U.S. declaration, assignment documents, an original certified copy of the application, a fee sheet and filing receipt. It should be appreciated that the drafting law firm 16 may also provide some or all of the information on behalf of the client 14, particularly where the law firm 16 has filed the application and has access to the documents.

Once the client order form information is received by the filing manager 12, the filing manager 12 downloads or enters the client's instructions and information relating to one or more legal documents into the filing manager database at step 106. The data from the order form 90 is loaded into various tables in the database. When foreign filing patent applications, the client provides data relating to one or more priority patent applications and specifies a list or “family” of countries in which such priority application is to be translated and/or filed. Data relating to the family is loaded into a family table. Such data includes but is not limited to the client, the person that placed the order, the client's reference number, the law firm that prepared the priority application, any special instructions from the client relating to the family of filings, and any other information that generally relates to the priority application being filed in multiple countries. All such general family data from one order form 90 makes up a single record in the family table. Each such family record includes a field for a unique family identification number that is automatically generated by the database and assigned to such family. This number is used to conventionally identify and link, or relate, each record in the family table to other records in other tables that contain data relating to the family record.

For example, each of the counties where the priority application is being filed is down loaded from the order form 90 into a country file table as a separate record. Each of these records in the country table includes the unique family identification number from the related family in the family table, such that each record in the country file table is related or linked to the related record in the family table. In addition to the country where the priority application is being filed, other data from the order form 90 that relates to each particular country filing is downloaded from the order form 90 into the country file table. For example, the client's file number for the filing in that country, the prosecuting agent that will prosecute the patent application in that country, the name of the corporate patent applicant in that country, whether examination is to be requested in that country, the filing type for the application being filed in that country, and any other data that relates specifically to the filing in this particular country.

Another table in the database related to the family table includes priority patent application data. This priority table includes a record for each previously filed patent application from which the client is making a claim of priority for the family of applications being filed. Again, each record in the priority table includes the unique family identification number that relates or links each priority table record to the related record in the family table. Data downloaded from the order form 90 into the priority table includes, the priority application number, the filing date or “priority date” of the priority application and the country or “priority country” in which the priority application was filed.

After the information from the order form 90 is downloaded, the filing manager 12 then performs an independent double-check to confirm the proper entry of data from the order form at step 108. The double-check may include querying an independent evaluator to review the client instructions on the order form against the data that has been entered into the system 10. Once the double-check is performed and proper data entry from the order form is verified, the filing manager 12 sends a confirmation report generated by the filing manager database to the client 14 at step 110 confirming that the instructions were received and entered. The confirmation report is generated by the filing manager 12 and includes downloaded order form data from the database. The confirmation report is sent to the client such that the client 14 may then perform an independent double-check of the confirmation report to compare the data on the confirmation report from the system 10 against the internal instructions that the client 14 used to fill out the order form 90 in step 112. Once the client confirms that the data in the confirmation report is correct, the client communicates this to the filing manager 12 and the client confirmation is recorded as complete.

With instructions received from the client 14 for filing certain legal documents and data from the order form 90 downloaded into the database tables and confirmed, the filing manager 12 forwards the filing order form or at least some of its content and instructions to the translation partner 18 at step 114 so that the information and client instructions can be entered into the translation partner database 66. At the translation partner 18, an independent double-check is performed to confirm the proper entry of the order form data into the translator database 66 at step 116.

Upon the client's communication to the filing manager 12 of the confirmation report being correct, the filing manager 12 also sends to the drafting law firm 16 a document check list generated by the filing manager database including the priority information for the applicable family from the priority table at step 118. The filing manager 12 populates the document checklist with applicable data and information, dependent upon the priority information, the countries where applications are being filed and the types of filings that have been ordered via the order form. The applicable data and information resides in the database in tables that are linked or related to other tables that contain the order form data and information, as set forth in the following paragraphs. As such, upon the existence of various combinations of criteria, such as priority information, filing country and/or the type of filing, the database automatically populates the document checklist with the applicable data and information linked to each combination.

In addition to the tables that contain client data from the order form 90, there are also tables in the database that include information relating to various rules and requirements for each filing type in each country. For example, the database contains a filing deadline table that has a unique record for each combination of country and filing type. Each of these records includes the country and filing type, as well as the number of days or months from the earliest priority date that such filing is due for this particular combination of country and filing type. Each record in this filing deadline table is related to each record in the country file table by common filing type and country fields. Accordingly the database can automatically relate the filing type and country for a record in the country file table to the related records in the priority table. The number of days or months in the filing deadline table can then be added to the earliest priority date in the related priority table to calculate a filing deadline date for the combination of filing type and country to be filed. Other criteria can be similarly entered into and used by the filing manager 12 to determine a filing deadline date. For example, if the filing deadline date for a particular country and filing type can be extended, such extension criteria can be entered into the filing manager database and used to determine the translation document deadline.

Likewise, the database also contains a country specific documents table that includes a unique record for each legal document required to be filed for each combination of country and filing type. Each of these records includes the country and filing type, as well as a name of the legal document required for filing in this country and filing type combination. Other information relating to the document may also be included in each record and there may be multiple records for a particular filing type in a particular country because multiple documents are required for such a filing. Accordingly the database can automatically relate the filing type and country for a record in the country file table to the related records in the country specific documents table. Each of the required documents can then be determined and automatically listed as needed for a particular filing, enabling a user of the system to readily request and inventory all documents necessary for the filing of a particular filing type in a particular country.

The database also includes a rules table. Each of the records in the country rules table includes the country and filing type, as well as each rule related to filing a patent application for this country and filing type combination. Other information relating to each rule may also be included in the applicable record and there may be multiple records for a particular filing type in a particular country because multiple rules apply to such a filing. Accordingly the database can automatically relate the filing type and country for a record in the country file table to the related records in the country rules table. Each of the required rules can then be determined and automatically listed as needed for a particular filing, enabling a user of the system to readily comply with all rules pertaining to the filing of a particular filing type in a particular country.

For the filing of patent application documents, the document checklist may includes a variety of data taken from the order form, a number of questions regarding the priority application, a list of documents that is required for each filing type and country listed on the order form, including a the required documents from the country specific documents table, as well as rules and other information relating to filing of one or more legal documents. For example, if a legal document such as a PCT International application for patent is being filed in the United States, a declaration document is required. As such, a declaration would be listed as country specific document in the country specific documents table, where the record included a filing type of PCT International and the country was the United States. Accordingly, such a declaration would be requested on the document checklist for a PCT International filing in the United States. If the declaration is due to be filed a by a certain date, this rule would be included in the applicable record of the rules table and could also be listed on the document checklist. Alternatively, if an application is not being filed in the United States, a declaration would not be requested on the document checklist. Other types of country specific documents can be included on the document checklist for other types of filings in a similar manner.

In another example, if patent applications are being filed as national phase filings of an International PCT application, a variety of documents relating to the related international phase PCT application are requested by the document checklist so that such documents can be provided by the drafting law firm to the filing manager and passed on to the prosecuting agents by the filing manager 12. If the filings are not for a PCT national phase filing type, these documents are not requested by the document checklist.

The filing manager database also calculates a deadline date for all documents requested on the document checklist to be provided to the filing manager 12. This deadline date is prominently displayed on the document checklist. In order to calculate a document deadline date, the filing manager utilizes the filing deadline table to calculate the filing deadline for each combination of filing type and country included on the client order form 90, as set forth above. The earliest of all filing deadlines is then determined. This earliest filing deadline is then compared to the current date to determine the amount of time remaining before the first filing is due. A document deadline date can then be calculated based upon the amount of time remaining before the first filing is due. For example, if the filing manager's charge for filing a patent application is dependent upon receiving documents two months in advance of the filing deadline and the current date is more than two months in advance of the filing deadline, then the document deadline date is automatically determined to be two months prior to the earliest filing deadline date. If the amount of time remaining between the current date and the earliest filing deadline date is less than two months, the document deadline date can be alternatively determined to be the date when one half the time remaining will be expired. Other criteria can be similarly entered into and used by the filing manager 12 to determine a document deadline date.

The filing manager 12 can also populate the document checklist with other information relating to the specific filings ordered. For example, a form legal document approved by the client such as an assignment or declaration, along with an instruction letter for submission of these legal documents to the inventors, can be included in the document checklist. This customized inclusion of such legal documents can assure the client 14 of a uniformly managed process where the creation and execution of such legal documents is controlled, even where multiple drafting counsel 16 are employed by one client 14. Such efficiency and customization within the document checklist leads to consistent legal documents that are executed and supplied in a timely manner. This in turn leads to cost savings over traditional handling by various drafting law firms and designated prosecution agents, each using their own procedures and multiple versions of legal documents.

When the drafting law firm 16 receives the documents checklist, it is asked to double-check the priority information listed on the document checklist against their own data in law firm database 56 at step 120. This priority information can include the priority filing dates, priority countries and the priority application numbers. The filing manager 12 also calculates and prominently displays a filing deadline date on the document checklist. As set forth above, this filing deadline date is calculated by the database of the filing manager 12 dependent upon the priority information, the country where applications are to be filed and the types of filings requested. The drafting law firm 16 is asked to check this filing deadline date against a filing deadline date calculated by the law firm database 56. If there is a discrepancy in any of the priority information or the filing deadline date, the drafting law firm 16 is asked to communicate the discrepancy to the filing manager 12. Otherwise, the drafting law firm 16 communicates to the filing manager that the information on the document checklist is accurate.

Next, the filing manager 12 receives the priority documents from the drafting law firm 16 at step 122. The filing manager 12 will then verify that the documents are complete and in a proper format at step 124 by checking the format of the computer files received by the filing manager.

Once the documents are verified to be complete and in a proper format, routine 100 identifies the countries where a patent application translation is required. The filing manager identifies where translation is required by comparing the county for each applicable filing, located in the country files table, to the country for the priority application in the priority application table. If the official language in the country where the priority application was filed is different from the official language in any country where an application is to be filed, then a translation is required. If translation is required, the filing manager 12 sends the application and amendments from the filing manager 12 to the translation partner 18 in step 126 along with a confirmation report generated by the filing manager database, similar to the confirmation report sent to client as set forth above.

The filing manager 12 calculates a deadline date for translation services to be completed and prominently displays it in the request for translation. Each of the applicable family filings requiring translation in a client order form 90 will be assigned a translation document deadline date that is calculated by the filing manager 12 as follows. The filing manager 12 utilizes the filing deadline table to calculate the filing deadline for each filing requiring translation, as set forth above. Each filing deadline is then compared to the current date to determine the amount of time remaining before the respective filing is due. A translation document deadline date can then be calculated based upon the amount of time remaining before the applicable translation is due. For example, if the translation partner generally requires three weeks to prepare a translation and the current date is more than three weeks in advance of the applicable filing deadline, the translation document deadline date is automatically determined to be three weeks from the current date. If the amount of time remaining between the current date and the applicable filing deadline date is less than three weeks, the translation document deadline date can be alternatively determined to be the date when one half the time remaining will be expired. Other criteria can be similarly entered into and used by the filing manager 12 to determine a translation document deadline date. For example, if a translation can be filed after the filing deadline date for a particular country and filing type, such extension criteria can be entered into the filing manager database and used to determine the translation document deadline.

The translation partner 18 employs one or more translators that are experts that can handle translations of documents in a specialized technological field, and the translators translate the application and amendments into one or more required languages. The confirmation report, which includes data from the filing manager database 36, is double-checked by the translation partner 18 against data in the translation partner database 66 at step 128. If there is a discrepancy between the data in the filing manager database 36 and the translation partner database 66, the translation partner 18 reports the discrepancy to the filing manager 12.

At step 130, the application translations are proofread by an independent linguist. The independent linguist may include a linguist with expertise in the specific language(s) of interest, whereas the original translation may be performed by a linguist having a technical background expertise relevant to the technology relating to the legal matter, such as a patent application technological field. Once the translations have been proofread, the filing manager 12 receives the translations from the translation partner 18 at step 132.

The filing manager 12 periodically conducts double-checks of matters due by manually comparing a filing report of cases due against the translation partner's report of cases due at step 134. This manual check off is between a user of the filing manager 12 and a user of the translation partner's database 66 to make sure that no filing deadlines are missed by the automated tracking in their respective systems.

In decision step 136, routine 100 will check whether localization of the claims has been requested by the client 14 or the drafting law firm 16 prior to the filing of the application. Request for localization may include modifying or amending the legal documents in compliance with local procedural requirements, such as providing or eliminating multiple dependent claims in a patent application, reducing the number of patent claims to reduce governmental fees, and other changes that are encouraged by the client 14, the drafting counsel or the prosecution agent. Localization is generally intended to optimize the application for filing in accordance with the local rules or statutes used by patent offices in those countries where filing has been ordered. If the localization is requested prior to filing, routine 100 proceeds to step 138 where the filing manager 12 requests localization from the drafting law firm 16 or the designated prosecuting agent 22 for implementation of the localization procedure. The filing manager 12 calculates a deadline date for localization and prominently displays it in the request. This localization deadline date is determined by the filing manager 12 using the same techniques as described above for determining the documents deadline date and the translation deadline date. The filing manager 12 can also attach a copy of any necessary documents required for localization. Once localization has been completed by the drafting law firm 16 or the designated prosecuting agent 22, they communicate the localized application to the filing manager 12.

If localization is not required or if localization has been completed, routine 100 proceeds to step 140 to send the filing document(s), which were received from the drafting law firm 16 in response to the document checklist and from the localizing agent if localization was performed, from the filing manager 12 to the filing agents 20 for filing in each of the respective countries at step 140. The filing agents 20 in each respective country are thereby instructed to file the application in compliance with local procedures. The filing manager calculates a deadline date for filing and prominently displays it in the instruction sent to the filing agent 20. Once the applications are filed in each designated country, the filing manager 12 receives a filing receipt and the applications as filed from the filing agents 20 in step 142. The filing manager 12 then forwards all documents to the designated prosecution agents 22 in step 144. It should be appreciated that the filing agents 20 are those agents that handle the initial filing of the legal documents in each foreign country, as opposed to the designated prosecution agents 22 which handle further continued prosecution after filing of the legal matters within each country. It should be appreciated that the filing agents 20 are designated by the filing manager 12, whereas the designated prosecution agents 22 may be designated by the client 14. It should further be appreciated that if a prosecuting agent 22 is not designated by the client, the filing manager may automatically designate the filing agents 20 as the prosecuting agents 22. In any event, the filing agents 20 may be the same as the designated prosecution agents 22, or may be different therefrom.

Regardless of who is designated as the filing agent 20 or the prosecution agent 22, if there are general instructions that a user of the system or a client 14 would like to have communicated to drafting agents 16, the filing agents 20 or the prosecuting agents 22, these instructions can be entered into a table in the filing manager database. In other words, a client 14 can specify that certain procedures or instructions be used when an ordered filing meets a particular criterion, such as the type of filing, filing in a particular country, or both. These general instructions can be entered into a record in an instructions table in the filing manager database. Thereafter, such records in the instructions table can be linked or related to other tables that contain the clients' order form data and information such as the client files table. In a relational database, these two types of tables are related or linked to one another by the criteria specified for the general instruction, for example, the filing type and/or the country where the application is being filed.

It should be noted that general instructions can be specified for a variety of criteria, including the type of filing, country, client, drafting agent, prosecuting agent, filing agent, priority country, filing deadline, or the like. When the criteria specified for a particular general instruction match the filing order form information for an application that is to be filed, the database will automatically populate the applicable instruction or request with the general instruction. This system 10 provides for timely and efficient filing of patent applications and avoids the costly multiple instruction letters that typically flow between the drafting agent and prosecution agents when clear and consistent instructions are not used.

For example, if client A wants to establish a general instruction that limits the amount any filing agent in Japan can charge for filing a PCT national application to $1,000, a statement explaining this limit, as well as the dollar limit, can be entered into a record in the instructions table in the database along with the criteria filing type=PCT national, country=Japan and client=A. Thereafter, any time client A orders a PCT National application to be filed in Japan, the database of the filing manager 12 will include a statement limiting charges to $1,000 in the filing instruction sent to the filing agent in Japan. Likewise, if the same priority application is filed in China, the filing manager will not include the statement regarding Japan, but will include a statement regarding China if such a statement has been requested by client A and entered into the general instruction table as set forth above.

Once the documents have been forwarded to the designated prosecution agents 22, the filing manager 12 receives an acknowledgement from the designated prosecution agents 22 at step 146 and forwards any documents required by the client 14 to the client 14 at step 148. Once the filing is complete and the documents have been forwarded to the client 14, routine 100 is complete at step 150. Accordingly, the filing manager 12 thereby implements and manages the filing and correspondence of the filing documents and transfers responsibility for prosecution to the designated prosecution agents 22 such that further responsibility for each filed legal matter is transferred and the filing responsibility of the filing manager 12 is completed for that matter.

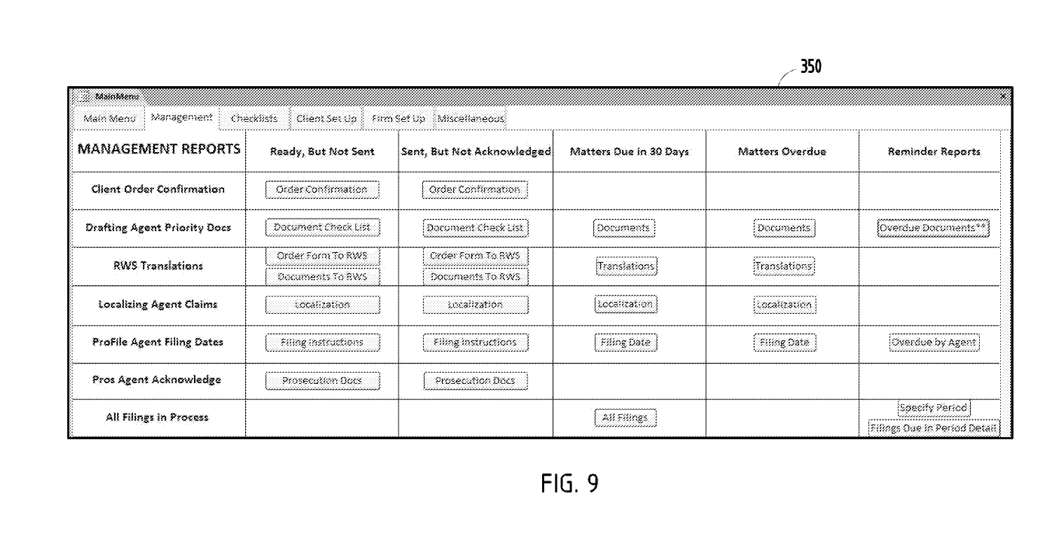

In order to manage the client 14 and its various service providers 16, 18, 20 and 22 in this process, it is necessary to make sure that each party's responsibilities are being performed in a timely manner. Accordingly, the filing manager 12 has a number of routines that test if services are being performed in a timely manner and whether services are complete when deadlines are approaching. A menu from the filing manager 12 is shown in FIG. 9 that depicts an interface 350 for a user of the filing manager 12 to executing these various routines, according to one embodiment. The interface 350 shows the various parties of the system and the status for handling a particular matter. The interface 350 manages the work requests that are sent to, and the work received from, the various parties. Included are management reports that show when documents are ready, but not sent, that show when documents are sent, but not acknowledged, that show matters that are due within a thirty day window and matters that are overdue, and that shows reminder reports. It should be appreciated that the reminder reports and other instructions may be displayed and automatically sent electronically to the appropriate parties, according to one embodiment. Alternately, reminder reports may be otherwise communicated by the filing manager 12.

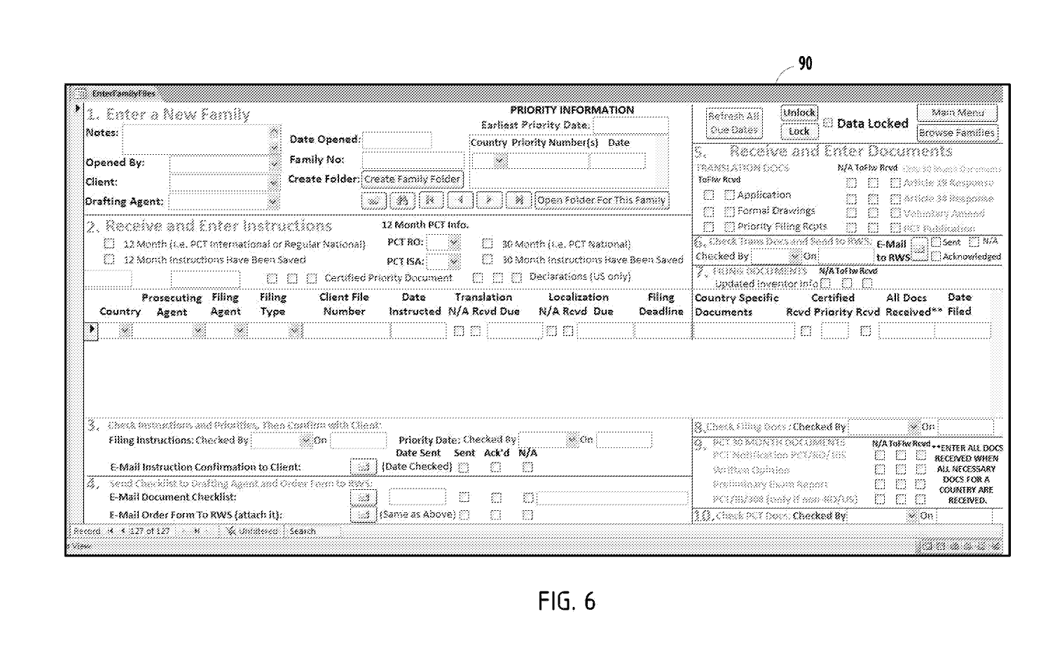

One exemplary embodiment of a routine executed by the filing manager 12 is a status routine 300 as shown in FIG. 7. The status monitoring routine 300 begins at step 302 and proceeds to step 304. For a selected work request or instruction, the routine 300 determines if work is to be performed and calculates a deadline date for any such work to be performed. The routine 300 then determines at step 306 whether the work has been completed and evaluates if a date associated with the completion of such work has been entered into the database of the filing manager. At step 308, routine 300 compares this date or the lack thereof to the deadline date for the work. In decision step 310, routine 300 determines if the party has completed the work by the deadline date and, if so, the routine 300 is completed at step 314. If the party has not completed the work by the deadline date, at step 312 routine 300 generates a report and sends a request to the responsible party to deliver the work, and returns at step 316. Accordingly, if the work has not been completed by the due date, routine 300 sends a message to the assigned service provider to deliver the work. Filing manager 12 continually monitors its progress until the work request or instruction is completed and the routine ends at step 314.

The reminder can be in the form of a report that reminds the applicable outside party responsible for the work that it is due, along with a matter number that identifies the patent application associated therewith. The responsible outside party referred to herein can be any of the service providers, including the drafting law firm 16, the translation partner 18, the filing agents 20 and the designated prosecution agents 22. In some instances, the reminder may identify the specific documents that have not been provided by a service provider in a timely manner. This report can also include the date a work request or instruction was sent, the date it is or was due and the filing deadline.

Routines within the filing manager 12 can also test if services have not been completed within a selected time period prior to the filing deadline, regardless of whether or not a deadline has been missed. This enables the filing manager 12 to determine if a particular application should be given priority and be more closely watched to ensure a filing deadline is not missed. Routines can also check if certain items have been received by the filing manager 12 and therefore a work request or instruction is ready to be generated and sent to the responsible service provider. Similarly, routines can then check whether such a work request or instruction has been acknowledged by the service provider as received.

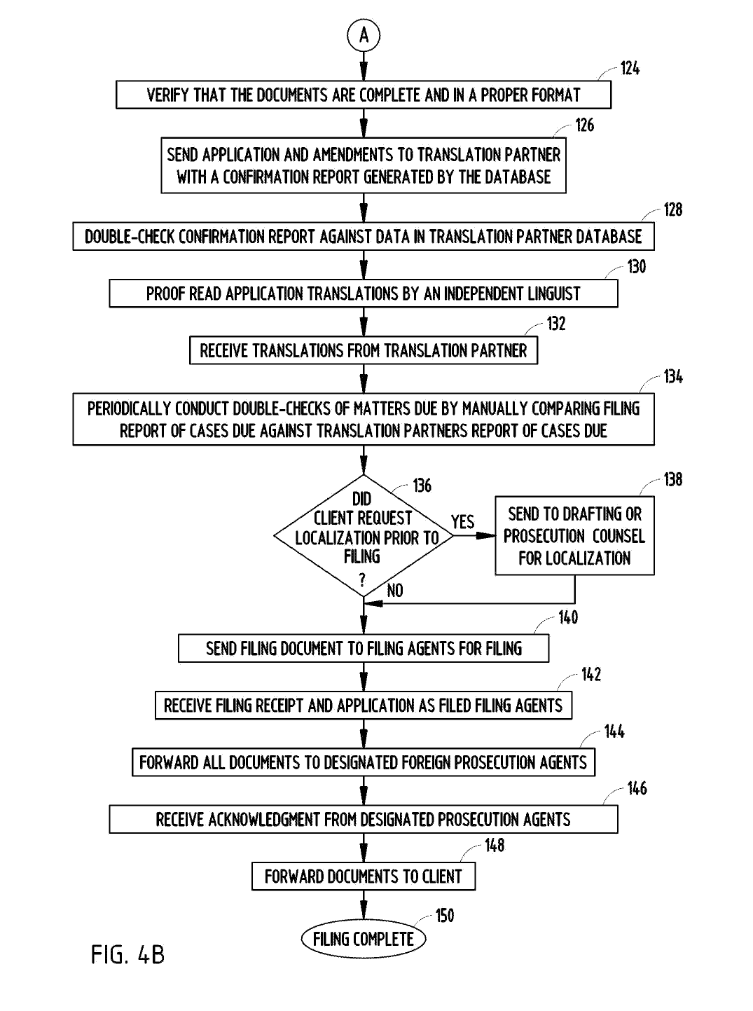

In another aspect of the invention, the filing manager 12 also executes an invoicing routine 200 which is shown in FIG. 5, according to one embodiment. The invoicing routine 200 begins at step 202 and proceeds to step 204 to receive data from the order form and calculate a filing deadline date for each legal matter handled. Next, routine 200 proceeds to step 206 to receive the documents for filing from the client or the drafting law firm, and further receives instructions for filing the documents in step 208. Routine 200 includes decision step 210 to determine if the documents and instructions were received more than two months prior to the deadline. If the documents and instructions were received more than two months prior to the deadline, routine 200 proceeds to step 212 to apply a discounted rate for invoicing the client for such services. If the documents and instructions were not received more than two months prior to the deadline but, as determined in decision step 214, the documents and instructions were received one month prior to the deadline, then routine 200 applies the standard invoicing rate at step 216. If the document and instructions were received in less than one month prior to the deadline, then routine 200 proceeds to step 218 to apply an expedited service rate for invoicing the client. Accordingly, it should be appreciated that the invoicing routine 200 provides an invoice rate for cost of services charged to the client based upon the time line for receiving the documents and instructions such that expedited services have a higher cost.

The invoicing routine 200 includes step 220 of invoicing services and estimated fees to the client based on the rates as determined in steps 212, 216 and 218 and upon government fees estimated at the time the documents and instructions are received. Thereafter, in step 222, one or more applications are filed pursuant to instructions from the client. In step 224, the estimated fees are compared to the actual governmental fees at the time of filing. It should be appreciated that the estimated fees invoiced at the time the instructions were received may be different from the actual fees at the time of filing due to changes in the expected costs. Therefore, the invoiced amounts for estimated fees are compared to actual fees and adjustments can be made.

For example, the governmental fees may change between the time of filing and the time of the instructions. In another example, the foreign exchange rate may change such that filing costs in one country may change based on changes in currency. As a further example, the fees at the time of filing as compared to the fees at the time of the instructions may vary based on changes to the legal matter, such as the number of claims, number of pages to the application, and other variations that may occur from the time of receiving the initial instructions to the time of the filing Finally, in step 226, the client is charged or credited for the difference between the estimated value and the actual value at the time of filing, on a subsequent invoice. Thus, routine 200 takes into consideration the differences in the fees at the time of filing and the time of receiving the instructions and either charges or credits the client for the difference. Finally, routine 200 then ends at step 228.

Accordingly, the system 10 advantageously manages the filing of patent applications to be filed in a plurality of offices by employing a client 14, a drafting law firm 16, a translation partner 18, one or more filing agents 20, a designated prosecution agent 22 and a filing manager 12. The filing manager 12 advantageously manages the filing of the patent applications in a plurality of offices and communicates with each of the client 14, the drafting law firm 16, the translation partner 18, and the filing agents 20 via a communication link and has a database to store data relevant to the filing of the patent applications. The filing manager 12 advantageously processes and executes a routine 100 to manage the filing of the one or more patent applications in a manner that is efficient and provides substantial cost savings to the client, with improved quality and reliability. The filing manager 12 advantageously reduces business costs by controlling the administrative costs for filing patent applications and advantageously eliminates manual re-entry and manual operations for handling the filing of the legal matter in offices throughout the world. The system and filing manager is advantageously usable as a tool to control costs for worldwide filings of patent applications and other legal documents, particularly by minimizing front end costs.

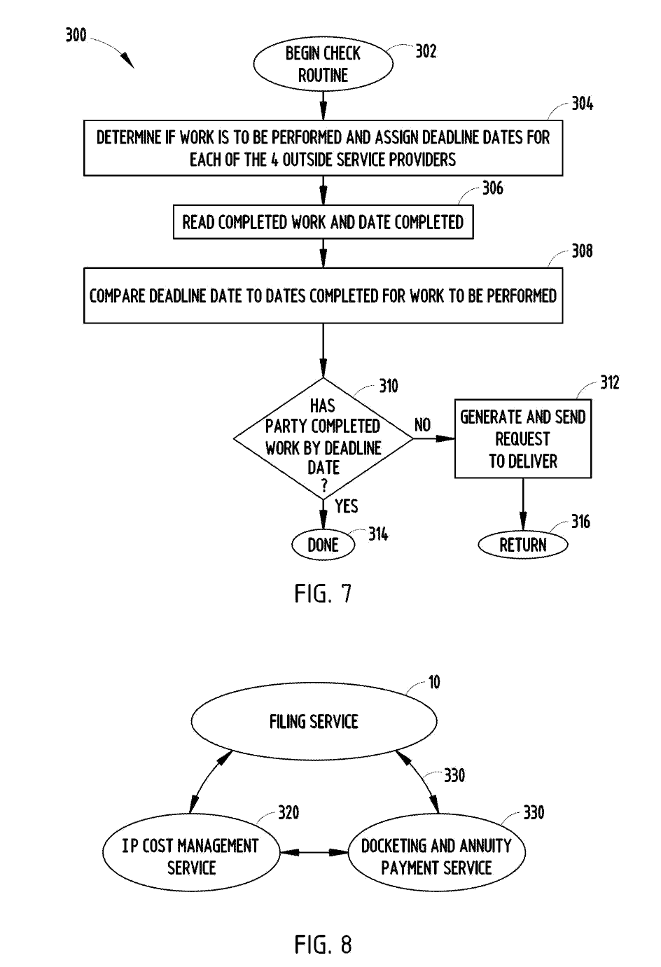

It should be appreciated that the filing service of system 10 and its filing manager 12 described herein may advantageously be employed in combination with other services, such as intellectual property cost management service 320 and docketing and annuity payment service 330, as shown in FIG. 8. In this example, the filing system 10 is employed to handle the filing of legal documents throughout the world. The filing system 10 may be integrated into a cost management service 320 and docketing and annuity service 330 to provide a more complete service package that handles the intellectual property “in-house” administrative needs for a client. In one embodiment, the filing system 10 and portions thereof may be integrated into a system for managing the legal matters, such as that described in PCT Application No. PCT/US2007/064062 entitled “METHOD AND SYSTEM FOR MANAGING LEGAL MATTERS,” filed on Mar. 15, 2007, the entire disclosure of which is incorporated herein by reference. In an alternative embodiment, the filing system 10 and portions thereof may also be integrated into and used in conjunction with a system for managing legal service providers, such as that described in PCT Application No. PCT/US2008/79805 entitled “SYSTEM AND METHOD FOR MANAGING LEGAL SERVICE PROVIDERS” filed on Oct. 14, 2008, the entire disclosure of which is incorporated herein by reference. In other embodiments, it should be appreciated that the filing system 10 or portions thereof may be integrated into other existing legal matter management systems such as the Master Data System provided by the Thomson Corporation location at 1 Station PI, Stamford, Conn. and the legal matter management system offered by Computer Packages Inc. located at 414 Hungerford Drive, Rockville, Md. Likewise, the filing system 10 or portions thereof could be integrated into other legal invoice management systems such as those provided by DataCert Inc. located at 3040 Post Oak Boulevard, Houston, Tex. and LexisNexis Examen Inc. located at 3831 North Freeway Boulevard, Sacramento, Calif.

In one embodiment, the filing database described herein is combined with the cost management database and/or the docketing and annuity payment service database referenced hereinabove. Each of these databases is a relational database and can therefore be related or linked to one another by common fields 340 in various tables. In one aspect of the present system, the combination of the client reference or “matter” number field and the country field are unique for each legal record and are common fields for each record in various tables in each of the above referenced databases. Accordingly, tables, queries, forms, reports, and the like in these or similar databases can be related or linked to one another by these common fields. Accordingly, a combined database of the present system can simultaneously support each of the respective administrative services in system 10, intellectual property cost management service 320 and docketing and annuity service 330 that these databases individually support, which are foreign filing management, cost management, matter management and annuity payment management.

By providing the combined database system in one aspect of the present invention, an even more efficient system is provided, where data entry into multiple systems is avoided, installation and training is minimized because a single system is used for these administrative services, and maintenance of the system is reduced since a single provider can deliver updates and perform maintenance on the system. As such, the system is more efficient and economical to use than the individual databases being used and standalone systems.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. A filing manager for managing the filing of legal documents in a plurality of offices for a client, said filing manager comprising:
a database for storing legal document related data relevant to the filing of a legal document;
a communication link adapted to communicate said legal document data within said database to a plurality of service providers; and
process circuitry configured to execute a routine to manage the filing of legal documents, said routine comprising the steps of receiving filing order form information relating to legal documents from a client and storing the filing order form information in the database, generating a request for information that is communicated to at least one of said service providers that prepared the legal documents, sending at least some of the order form information to a translation partner when translation into one or more appropriate languages is required, receiving one or more translations from the translation partner, sending filing documents to one or more filing agents for filing in appropriate offices, sending filing documents to prosecution agents in designated countries, and sending a confirmation of filing to the client.

2. The filing manager as defined in claim 1, wherein the legal document is at least one of a group comprising a patent application, a utility model application, a design application, a trademark application and a copyright application.

3. The filing manager as defined in claim 1, wherein the communication link communicates with at least one of a group of service providers comprising a drafting law firm, the translation partner, and one or more filing agents.

4. The filing manager as defined in claim 3, wherein the process circuitry checks the data entered into the database for accuracy and compares the data in the database with data stored in another database in one of the service providers.

5. The filing manager as defined in claim 3, wherein the client comprises a client database, the law firm comprises a law firm database, and the translation partner comprises a translator database, and said communication link is adapted to provide communications to said client, said law firm and said translation partner that include said legal document data such that said legal document data can be checked against independently entered data within each of said client database, said law firm database and said translation partner database, thereby providing a mechanism for three independent checks on the integrity of said legal document data residing in said database.

6. The filing manager as defined in claim 1, wherein the communication link communicates with the client to receive the filing order form information.

7. The filing manager as defined in claim 1, wherein the process circuitry further generates a document checklist and said communication link communicates the checklist to a drafting law firm, said document checklist includes at least some legal document data and requests information and documents that are required for a specific type of filing and a specific country requested by the client.

8. The filing manager as defined in claim 1, wherein the communication link comprises e-mail communication.

9. The filing manager as defined in claim 1, wherein the filing manager comprises a web site and wherein the communication link communicates with the plurality of service providers via the web site.

10. The filing manager as defined in claim 1, wherein the routine further sends filed documents to one or more designated prosecution agents for prosecution of the legal document.

11. A filing management system for managing the filing of patent applications to be filed in a plurality of patent offices located in various countries, said system comprising:
a filing manager database for storing patent application data relating to individual patent applications, and general instruction data relating to general instructions and criteria for determining when said general instructions should be used;
a communication link adapted to communicate instructions and requests, which relate to patent application data and general instruction data stored within said filing manager database, between said filing manager database and a client, a service provider that prepared said patent application, a translation partner and a prosecuting agent; and
process circuitry for managing the timely filing of one or more patent applications and configured to execute routines that manage the communication of said instructions and said requests via said communication link and further configured to execute one or more routines that use said patent application data to calculate a patent application filing deadline date and deadline dates for each of the instructions and the requests communicated, and that determine if said instructions and requests have been responded to before said deadline and before said filing deadline date.

12. The system as defined in claim 11, wherein at least one of said routines comprises the steps of receiving application filing order form information and storing the application order form information in the filing manager database, generating a request for information and communicating said request to said service provider that prepared the patent application via the communication link, sending at least some of the order form information to the translation partner for translation to one or more appropriate languages, receiving one or more translations from the translation partner, sending filing documents to filing agents for filing of the patent application in appropriate offices, and forwarding confirmation of the filed documents to the client.

13. The system as defined in claim 11, wherein the service provider that prepared the application comprises a law firm database, the translation partner comprises a translator database, and the client comprises a client database, and data pertaining to the filing of the patent application is stored in each of the filing manager database, the law firm database, the client database, and the translator database and wherein said communication link adapted to provide communications to said client, said law firm and said translation partner that include said patent application data such that said patent application data can be checked against independently entered data within each of said client database, said law firm database and said translation partner database, thereby providing a mechanism for three independent checks on the integrity of said patent application data residing in said filing manager database.

14. The system as defined in claim 11, wherein said communication link communicates with each of the client, law firm, translator, and filing agents by using at least one of a group of communication links comprising e-mail, telephone, web application and web site.

15. The system as defined in claim 11, wherein the process circuitry further generates a document checklist that is communicated to a drafting law firm via said communication link, said document checklist requests priority document information and other documents that are required for specific types of filings in specific counties requested by said client.

16. A method for managing the filing of legal documents in a plurality of offices for a client, said method comprising the steps of
receiving legal document filing order form information from a client that designates at least one country where said legal documents are to be filed;
storing the filing order form information in a database in a filing manager;
using a routine within said database to calculate at least one filing deadline for filing of said legal documents;
generating a request for information including a deadline for receiving said information and communicating said request to a service provider that prepared the legal documents;
communicating to a translation partner at least some of the order form information, and a request for translation of the legal documents into one or more appropriate languages for the countries designated by the client that require translation;
receiving one or more translations from the translation partner;
sending filing documents to one or more filing agents for filing in appropriate offices;
receiving confirmation of the filing of legal documents in foreign offices; and
forwarding a confirmation of filing to the client.

17. The method as defined in claim 16 further comprising the step of sending the filed documents to designated prosecution agents for continued prosecution of the legal matter.

18. The method as defined in claim 16 further comprising the step of receiving priority document information from a drafting law firm.

19. The method as defined in claim 16 further comprising sending at least a portion of said order form information to a service provider and a request that said service provider localize the legal documents.

20. The method as defined in claim 16, wherein the steps of receiving and transmitting comprise communicating via by using at least one of a group of communication links comprising e-mail, telephone, web application and web site.
